(19) United States
(12) Patent Application Publication
(10) Pub. No.: US 2005/0169376 A1
(43) Pub. Date: Aug. 4, 2005

(54) Motion vector address computer error detection

(76) Inventors: Ramadas Lakshmikanth Pai, Bangalore (IN); Srinivas Cheedella, Bangalore (IN); Manoj Vajhallya, Bangalore (IN)

Correspondence Address: MCANDREWS HELD & MALLOY, LTD, 500 WEST MADISON STREET, SUITE 3400, CHICAGO, IL, 60661, US

(21) Appl. No.: 10/816,320

(22) Filed: Apr. 1, 2004

Related U.S. Application Data
(60) Provisional application No. 60/540,579, filed on Jan. 30, 2004.

(51) Int. Cl. H04N 7/12

(52) U.S. Cl. 375/240.16; 348/699; 375/240.25; 375/240.24

(57) ABSTRACT

Described herein is a video decoding related system and method for error detection in a motion vector address computer. A circuit determines addresses for reference pixels. The circuit comprises an input and logic. The input receives parameters comprising a picture type indicator for indicating a type of a picture. The logic determines whether the parameters received by the input are valid.

### RELATED APPLICATIONS

This application claims priority to Provisional Application for Patent, Ser. No. 60/540,579, entitled “Motion Vector Address Computer Error Detection”, filed Jan. 30, 2004, by Pai, and incorporated herein by reference.

### FEDERALLY SPONSORED RESEARCH OR DEVELOPMENT

[Not Applicable]

### MICROFICHE/COPYRIGHT REFERENCE

[Not Applicable]

### BACKGROUND OF THE INVENTION

Common video compression algorithms use compression based on temporal redundancies between pictures in the video. For example, MPEG-2 defines pictures that can be predicted from one other picture (a P-picture), two pictures (a B-picture), or not predicted from another picture at all (an I-picture).

Portions, known as macroblocks, from B and P pictures are predicted from reference pixels in a reference picture. The reference pixels can be spatially displaced from the macroblock that is predicted therefrom. Accordingly, the macroblock is encoded, along with indicator(s) indicating the spatial displacements of the reference pixels from the position of the macroblock. The indicator(s) is known as a motion vector.

During decoding, the motion vectors are used to retrieve the reference pixels. The reference pixels are retrieved from a memory storing the reference frame. The memory storing the reference frame is known as a frame buffer. A motion vector address computer determines the appropriate addresses storing the reference pixels for a macroblock, based on motion vectors.

The motion vectors and other information are provided to the motion vector address computer as parameters. However, the motion vector addresses can be corrupted for a variety of reasons. Where the parameters are corrupted, and where such corruption is undetected, the motion vector address computer proceeds to attempt calculation of the address for the reference pixels.

Further limitations and disadvantages of conventional and traditional approaches will become apparent to one of ordinary skill in the art through comparison of such systems with the present invention as set forth in the remainder of the present application with reference to the drawings.

### BRIEF SUMMARY OF THE INVENTION

Described herein is a system and method for error detection in a motion vector address computer.

In one embodiment, there is presented a circuit for determining addresses for reference pixels. The circuit comprises an input and logic. The input receives parameters comprising a picture type indicator for indicating a type of a picture. The logic determines whether the parameters received by the input are valid.

In another embodiment, there is presented a method for determining addresses for reference pixels. The method comprises receiving parameters, the parameters comprising a picture type indicator for indicating a type of a picture; determining the validity of the parameters; and calculating one or more addresses after determining the validity of the parameters, and if the parameters are valid.

In another embodiment, there is presented a video decoder for decoding macroblocks. The video decoder comprises a processor, a motion vector address computer, and a video request manager. The processor decodes a set of parameters. The set of parameters comprises a picture type parameter indicating a type of picture and motion vectors indicating reference pixels associated with the macroblock. The motion vector address computer determines the validity of the set of parameters, and calculates addresses associated with motion vectors if the set of parameters are valid. The video request manager fetches reference pixels at the addresses calculated by the motion vector address computer, if the motion vector address computer determines that the set of parameters are valid.

These and other features and advantages of the present invention may be appreciated from a review of the following detailed description of the present invention, along with the accompanying figures in which like reference numerals refer to like parts throughout.

### BRIEF DESCRIPTION OF SEVERAL VIEWS OF THE DRAWINGS

FIG. 1a is a block diagram of an exemplary Moving Picture Experts Group (MPEG) encoding process, in accordance with an embodiment of the present invention.

FIG. 1b is an exemplary sequence of frames in display order, in accordance with an embodiment of the present invention.

FIG. 1c is an exemplary sequence of frames in decode order, in accordance with an embodiment of the present invention.

FIG. 2 is a block diagram of an exemplary decoder system in accordance with an embodiment of the present invention;

FIG. 3 is a flow diagram describing the operation of the motion vector address computer in accordance with an embodiment of the present invention;

FIG. 4 is a block diagram of an exemplary video decoder in accordance with an embodiment of the present invention; and

FIG. 5 is a block diagram describing a motion vector address computer in accordance with an embodiment of the present invention.

### DETAILED DESCRIPTION OF THE INVENTION

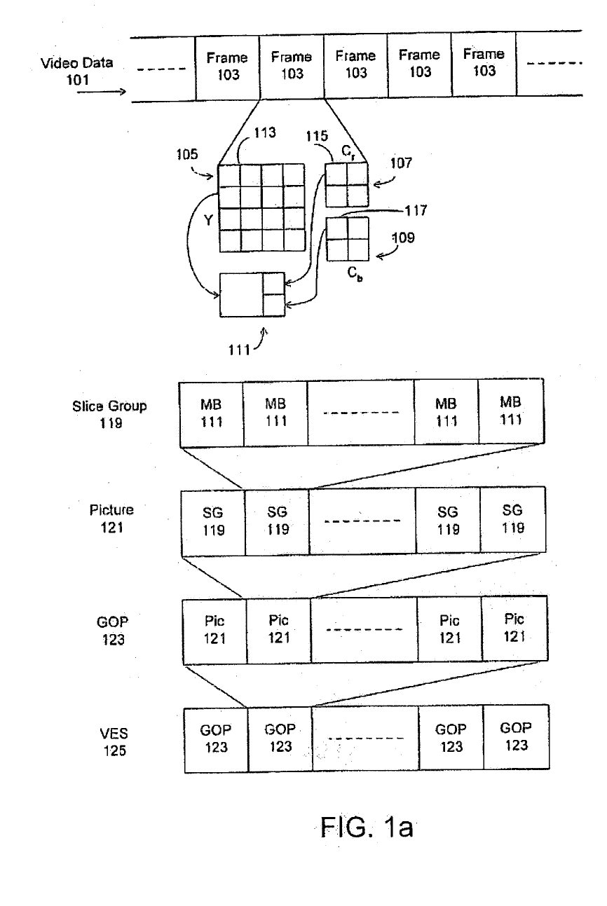

FIG. 1a illustrates a block diagram of an exemplary Moving Picture Experts Group (MPEG) encoding process of video data 101, in accordance with an embodiment of the present invention. The video data 101 comprises a series of frames 103. Each frame 103 comprises two-dimensional grids of luminance Y, 105, chrominance red Cr, 107, and chrominance blue Cb, 109, pixels. The two-dimensional grids are divided into 8×8 blocks, where a group of four blocks or a 16×16 block 113 of luminance pixels Y is associated with a block 115 of chrominance red Cr, and a block 117 of chrominance blue Cb pixels. The block 113 of luminance pixels Y, along with its corresponding block 115 of chrominance red pixels Cr, and block 117 of chrominance blue pixels Cb form a data structure known as a macroblock 111. The macroblock 111 also includes additional parameters, including motion vectors, explained hereinafter. Each macroblock 111 represents image data in a 16×16 block area of the image.

The data in the macroblocks 111 is compressed in accordance with algorithms that take advantage of temporal and spatial redundancies. For example, in a motion picture, neighboring frames 103 usually have many similarities. Motion causes an increase in the differences between frames, the difference being between corresponding pixels of the frames, which necessitate utilizing large values for the transformation from one frame to another. The differences between the frames may be reduced using motion compensation, such that the transformation from frame to frame is minimized. The idea of motion compensation is based on the fact that when an object moves across a screen, the object may appear in different positions in different frames, but the object itself does not change substantially in appearance, in the sense that the pixels comprising the object have very close values, if not the same, regardless of their position within the frame. Measuring and recording the motion as a vector can reduce the picture differences. The vector can be used during decoding to shift a macroblock 111 of one frame to the appropriate part of another frame, thus creating movement of the object. Hence, instead of encoding the new value for each pixel, a block of pixels can be grouped, and the motion vector, which determines the position of that block of pixels in another frame, is encoded.

Accordingly, many of the macroblocks 111 are compared to pixels of other frames 103 (reference frames). When an appropriate (most similar, i.e. containing the same object(s)) portion of a reference frame 103 is found, the differences between the portion of the reference frame 103 (reference pixels) and the macroblock 111 are encoded. The difference between the portion of the reference frame 103 and the macroblock 111, the prediction error, is encoded using the discrete cosine transformation, thereby resulting in frequency coefficients. The frequency coefficients are then quantized and Huffman coded.

The location of the reference pixels in the reference frame 103 is recorded as a motion vector. The motion vector describes the spatial displacement between the macroblock 111 and the reference pixels. The encoded prediction error and the motion vector form part of the data structure encoding the macroblock 111. In the MPEG-2 standard, the macroblocks 111 from one frame 103 (a predicted frame) are limited to prediction from reference pixels of no more than two reference frames 103. It is noted that frames 103 used as a reference frame for a predicted frame 103 can be a predicted frame 103 from another reference frame 103.

The macroblocks 111 representing a frame are grouped into different slice groups 119. The slice group 119 includes the macroblocks 111, as well as additional parameters describing the slice group. Each of the slice groups 119 forming the frame form the data portion of a picture structure 121. The picture 121 includes the slice groups 119 as well as additional parameters that further define the picture 121.

The progressive frame parameter indicates whether the picture has been encoded as a progressive frame. If the bit is set, the picture has been encoded as a progressive frame. If the bit is not set, the picture has been encoded as an interlaced frame.

The prediction type parameter specifies the prediction type. The prediction type can include frame prediction, field prediction, dual prime, and 16×8 MC. The picture type parameter indicates whether the picture is an I-picture, a P-picture, or a B-picture.

I₀, B₁, B₂, P₃, B₄, B₅, and P₆, FIG. 1b , are exemplary pictures. The arrows illustrate the temporal prediction dependence of each picture. For example, picture B₂ is dependent on reference pictures I₀, and P₃. Pictures coded using temporal redundancy with respect to exclusively earlier pictures of the video sequence are known as predicted pictures (or P-pictures) , for example picture P₃ is coded using reference picture I₀. Pictures coded using temporal redundancy with respect to earlier and/or later pictures of the video sequence are known as bi-directional pictures (or B-pictures), for example, pictures B₁ is coded using pictures I₀ and P₃. Pictures not coded using temporal redundancy are known as I-pictures, for example I₀. In the MPEG-2 standard, I-pictures and P-pictures are also referred to as reference pictures.

The foregoing data dependency among the pictures requires decoding of certain pictures prior to others. Additionally, the use of later pictures as reference pictures for previous pictures requires that the later picture be decoded prior to the previous picture. As a result, the pictures may be decoded in a different order than the order in which they will be displayed on the screen. Accordingly, the pictures are transmitted in data dependent order, and the decoder reorders the pictures for presentation after decoding. I₀, P₃, B₁, B₂, P₆, B₄, B₅, FIG. 1c, represent the pictures in data dependent and decoding order, different from the display order seen in FIG. 1b.

The pictures are then grouped together as a group of pictures (GOP) 123. The GOP 123 also includes additional parameters further describing the GOP. Groups of pictures 123 are then stored, forming what is known as a video elementary stream (VES) 125. The VES 125 is then packetized to form a packetized elementary sequence. Each packet is then associated with a transport header, forming what are known as transport packets.

The transport packets can be multiplexed with other transport packets carrying other content, such as another video elementary stream 125 or an audio elementary stream. The multiplexed transport packets form what is known as a transport stream. The transport stream is transmitted over a communication medium for decoding and displaying.

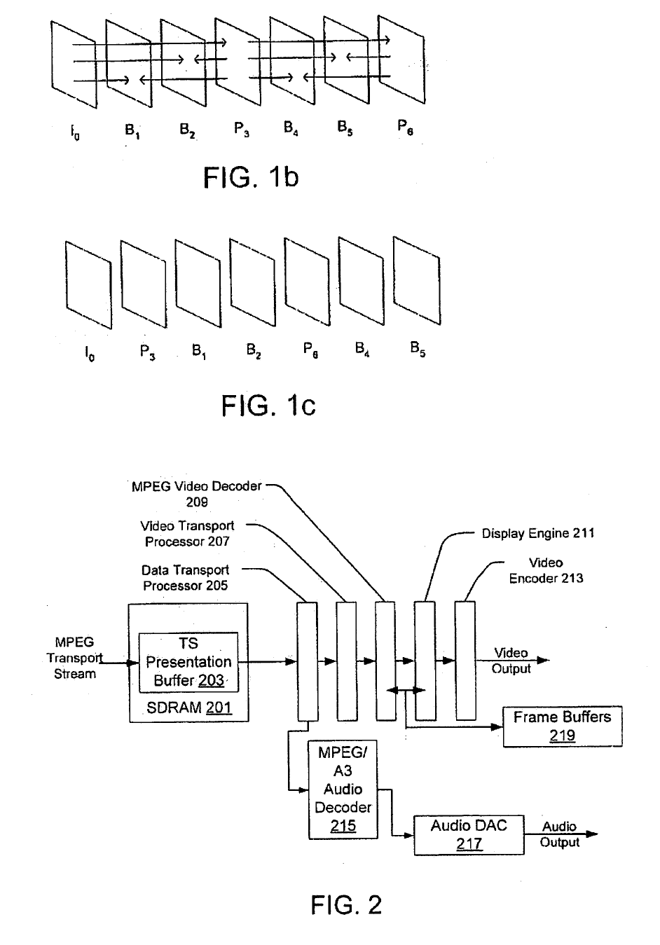

FIG. 2 illustrates a block diagram of an exemplary circuit for decoding the compressed video data, in accordance with an embodiment of the present invention. Data is received and stored in a presentation buffer 203 within a Synchronous Dynamic Random Access Memory (SDRAM) 201. The data can be received from either a communication channel or from a local memory, such as, for example, a hard disc or a DVD.

The data output from the presentation buffer 203 is then passed to a data transport processor 205. The data transport processor 205 demultiplexes the transport stream into packetized elementary stream constituents, and passes the audio transport stream to an audio decoder 215 and the video transport stream to a video transport processor 207 and then to a MPEG video decoder 209. The audio data is then sent to the output blocks, and the video is sent to a display engine 211.

The display engine 211 scales the video picture, renders the graphics, and constructs the complete display. Once the display is ready to be presented, it is passed to a video output encoder 213 where it is converted to analog video using an internal digital to analog converter (DAC). The digital audio is converted to analog in an audio digital to analog converter (DAC) 217.

The decoder 209 decodes at least one picture, I₀, B₁, B₂, P₃, B₄, B₅, P₆ . . . during each frame display period. Due to the presence of the B-pictures, B₁, B₂, the decoder 209 decodes the pictures, I₀, B₁, B₂, P₃, B₄, B₅, P₆ . . . in an order that is different from the display order. The decoder 209 decodes each of the reference pictures prior to each picture that is predicted from the reference picture. For example, the decoder 209 decodes I₀, B₁, B₂, P₃, in the order, I₀, P₃, B₁, and B₂. After decoding I₀, the decoder 209 writes I₀ to a frame buffer 220 and decodes P₃. the frame buffer 220 can comprise a variety of memory systems, for example, a DRAM. The macroblocks of P₃ are encoded as prediction errors with respect to reference pixels in I₀. The reference pixels are indicated by motion vectors that are encoded with each macroblock of P₃. Accordingly, the video decoder 209 uses the motion vectors encoded with the macroblocks of P₃ to fetch the reference pixels. Similarly, the video decoder 209 uses motion vectors encoded with the macroblocks of B₁ and B₂ to locate reference pixels in I₀ and P₃.

To fetch the reference pixels from I₀, the video decoder 209 calculates the frame buffer 220 addresses storing the reference pixels, based on the motion vectors. A circuit known as a motion vector address computer calculates the frame buffer addresses. The video decoder 209 then fetches the pixels at the addresses calculated by the motion vector address computer in the frame buffer 220.

It is noted that errors can be introduced into the video elementary stream. As a result, the video data, as well as the encoded parameters can be corrupted or erroneous. In the case of motion vectors, errors or corrupted data can result in decoding inaccurate motion vectors, detection of additional motion vectors that are not valid (false positive), and the failure to detect valid motion vectors (false negative). Attempting to calculate the addresses of the reference pixels with the corrupted data can have a deleterious affect on performance. Accordingly, the motion vector address computer includes error detection logic that detects invalid parameter sets and prevents further processing of erroneous or corrupted data.

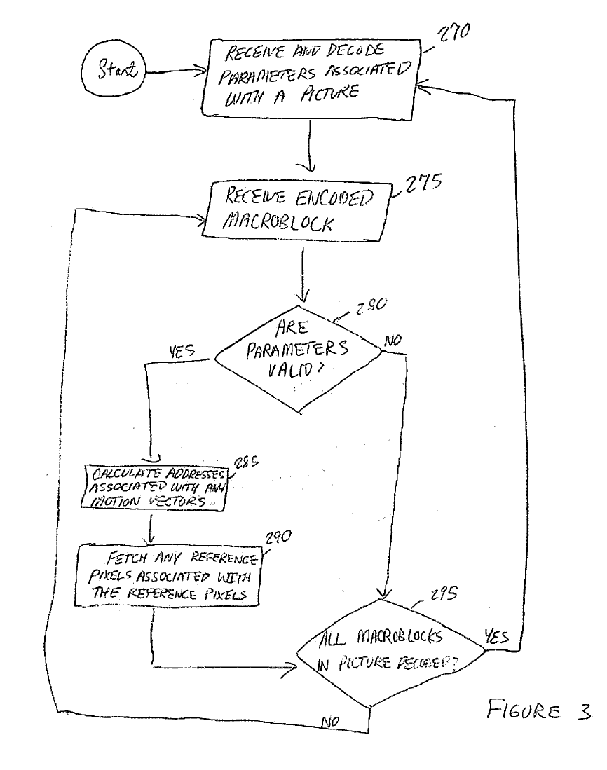

Referring now to FIG. 3, there is illustrated a flow diagram describing the operation of the video decoder 209 in accordance with an embodiment of the present invention. At 270, the video decoder 209 receives and decodes parameters associated with a picture 121. The parameters can include, for example, the picture type parameter, the progressive frame parameter, and the prediction type parameter. At 275, the video decoder 209 receives an encoded macroblock 111 from the picture for decoding. At 280, the video decoder 209 determines, based on the picture type, prediction type, picture structure, and the number of motion vectors received with the macroblock 111, whether the foregoing parameters are valid. If at 280, the foregoing parameters are valid, the video decoder 209 calculates the address(es) (285) associated with any of the motion vectors, and fetches any reference pixels (290) associated with the motion vectors. If at 280, the foregoing parameters are not invalid, the video decoder 209 bypasses 285 and 290. In either case, 275-295 are repeated for each macroblock ill in the picture 121 until all the macroblocks 111 in the picture are decoded at 295. When all of the macroblocks 111 in the picture are decoded at 295, 270-295 are repeated for the next picture.

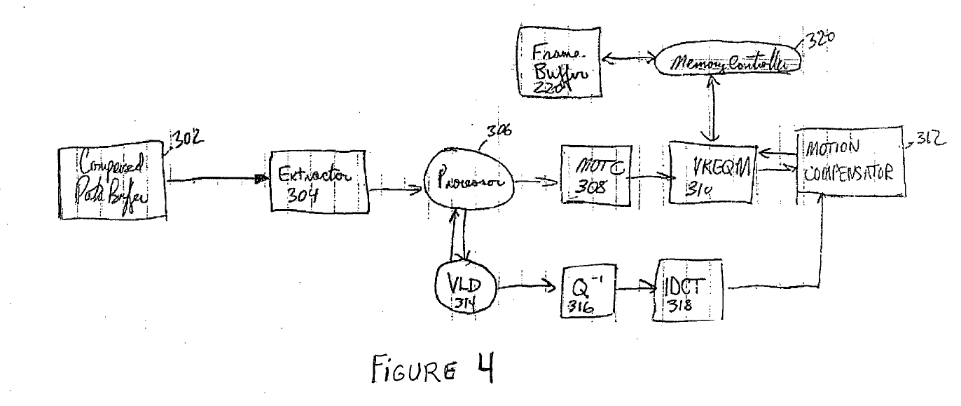

Referring now to FIG. 4, there is illustrated a block diagram of an exemplary video decoder 209 in accordance with an embodiment of the present invention. The video decoder 209 comprises a compressed data buffer 302, an extractor 304, a processor 306, a motion vector address computer 308, a video request manager 310, a motion compensator 312, a variable length decoder 314, an inverse quantizer 316, and an inverse discrete cosine transformation module 318.

The video decoder 209 fetches data from the compressed data buffer 302, via an extractor 304 that provides the fetched data to a processor 306. the video decoder 209 decodes at least one picture per frame display period on a macroblock by macroblock basis. At least a portion of the data forming the picture is encoded using variable length code symbols. Accordingly, the variable length coded symbols are provided to a variable length decoder 314. The portions of the data that can be encoded using variable length codes can include the parameters, such as picture type, prediction type, progressive frame, and the motion vectors, as well as the encoded pixel data (frequency coefficients). The parameters are provided to the processor 306, while the frequency coefficients are provided to the inverse quantizer 316. The inverse quantizer 316 inverse quantizes the frequency coefficients and the IDCT module 318 transforms the frequency coefficients to the pixel domain.

If the macroblock is from an I-picture, the pixel domain data represents the pixels of the macroblock. If the macroblock is from a P-picture, the pixel domain data represents the prediction error between the macroblock and reference pixels from one other frame. If the macroblock is from a B-picture, the pixel domain data represents the prediction error between the macroblock and reference pixels from two other frames.

Where the macroblock is from a P or B picture, the video decoder 209 fetches the reference pixels from the reference frame(s) 103. The reference frame(s) is stored in a frame buffer(s) 220. The processor 306 provides the motion vectors encoded with the macroblock 111 to the motion vector address computer 308. The motion vector address computer 308 uses the motion vectors to calculate the address of the reference pixels in the frame buffer 220.

When the motion vector address computer 308 calculates the addresses associated with the reference pixels, the video request manager 310 fetches the reference pixels at the addresses calculated by the motion vector address computer 308, via memory controller. The reference pixels are then provided to a motion compensator 312. The motion compensator 312 applies the prediction error from the macroblock 111 to the fetched reference pixels, resulting in the decoded macroblock 111. The video request manager 310 then writes the decoded macroblock 111 to the frame buffer 220, using the memory controller.

The motion vector address computer 308 includes error detection logic that detects invalid parameter sets and prevents further processing of erroneous or corrupted data. The error detection logic examines the parameters that are provided to the motion vector address computer 308 to determine whether the parameters are valid. Based on the number of motion vectors provided, the type of picture (I, P, or B-picture), the prediction type, and the progressive frame parameters, the error detection logic determines whether the received parameters are valid. If the parameters are not valid, the error detection logic prevents further processing by the motion vector address computer 308.

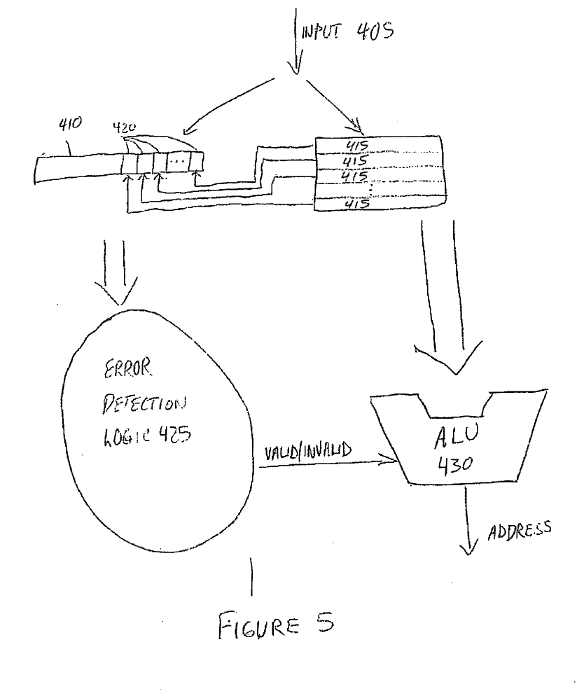

Referring now to FIG. 5, there is illustrated a block diagram of an exemplary motion vector address computer 308. The motion vector address computer 308 comprises an input 405 for receiving parameters. The parameters include the picture type, the progressive frame and prediction type parameters, and zero or a number of motion vectors.

A control register 410 stores the picture type parameter, progressive frame parameter, and the prediction type parameter. Motion vector registers 415 store the motion vectors. The motion vector registers 415 are cleared prior to receiving the motion vectors. The control register 410 comprises a plurality of bits 420, each of which are associated with a corresponding one of the motion vector registers 415. The bits are in a particular state, such as set, based on whether the corresponding motion vector register 415 is loaded with a motion vector.

Accordingly, the control register 410 includes indicators indicating the picture type, whether the picture is progressive, the prediction type, and the number of motion vectors received (the number of bits 420 that are set). Error detection logic 425 examines the control register 410 and determines, based on the picture type parameter, progressive parameter, and whether the number of motion vectors received is correct. If the number of motion vectors received is correct, based on the picture type, prediction type, and progressive frame parameters, the error detection logic 425 indicates that the parameters are valid. If the number of motion vectors received is not correct, the error detection logic 425 indicates that the parameters are not valid.

The following table represents the valid sets of parameters:

| Picture Type | Prog. Frame | Pred. Type | #MV |
|---|---|---|---|
| I | Any | Any | 0 |
| P | Frame | Frame Prediction | 1 |
| | | Field Prediction | 2 |
| | | Dual Prime | 4 |
| B | Frame | Frame Prediction | 2 |
| | | Field Prediction | 4 |
| P | Field | Field Prediction | 1 |
| | | Dual Prime | 2 |
| | | 16x8 MC | 2 |
| B | Field | Field Prediction | 2 |
| | | 16x8 MC | 4 |

The error detection logic 425 can comprises a state machine or appropriate combinatorial logic gates that determine whether the control register 410 contents corresponds to one of the combinations listed in the table above. Where the control register 410 contents corresponds to one of the combinations listed in the table above, the error detection logic 425 determines that the received parameters are valid. Where the control register 410 contents does not correspond to one of the combinations listed in the table above, the error detection logic 425 determines that the received parameters are not valid.

Where the error detection logic 425 determines that the parameters received are valid, the error detection logic 425 signals the foregoing to the processor 306. If the parameters are valid, the processor commands the arithmetic logic unit 430 to calculate addresses. The arithmetic logic unit 430 receives the motion vectors, via the motion vector registers 415. The arithmetic logic unit 430 calculates the addresses storing the reference pixels indicated by the motion vectors. The addresses calculated by the arithmetic logic unit 430 are provided to the video request manager 310. The video request manager 310 then fetches the reference pixel corresponding to the addresses calculated by the arithmetic logic unit 425.

Where the error detection logic unit 425 determines that the parameters received are invalid, the error detection logic 425 signals the foregoing to the processor 306. The processor 306 can then take appropriate action.[IPai_Bkar3]the T. [IPai_Bkar4] For example, For exFFin the presence of an error, the processor 306 can withhold commanding the arithmetic logic unit 425 to calculate addresses. In such as case, the MOTC does not provide addresses to the video request manager.

The embodiments described herein may be implemented as a board level product, as a single chip, application specific integrated circuit (ASIC), or with varying levels of the decoder system integrated with other portions of the system as separate components. The degree of integration of the decoder system will primarily be determined by the speed and cost considerations. Because of the sophisticated nature of modern processor, it is possible to utilize a commercially available processor, which may be implemented external to an ASIC implementation. Alternatively, if the processor is available as an ASIC core or logic block, then the commercially available processor can be implemented as part of an ASIC device wherein certain functions can be implemented in firmware.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

1. A circuit for determining addresses for reference pixels, said circuit comprising:
an input for receiving parameters, the parameters comprising a picture type indicator for indicating a type of a picture; and
logic for determining whether the parameters received by the input are valid.

2. The circuit of claim 1, further comprising:
an arithmetic logic unit for calculating one or more addresses depending on whether the logic determines that the addresses are valid.[IPai_Bkar5]

3. The circuit of claim 1, wherein the logic determines whether the parameters received by the input are valid based on the picture type indicator and the number of motion vectors received by the input.

4. The circuit of claim 3, further comprising:
a control register for providing the type of pictures and indicating the number of motion vectors received to the logic.

5. The circuit of claim 4, further comprising:
one or more motion vector registers for storing motion vectors received by the input; and
wherein the control register comprises one or more bits, each of which are associated with a corresponding one or the one or more motion vector registers, wherein the one or more bits are in a particular state, based on whether the corresponding motion vector register stores a motion vector.

6. The circuit of claim 5, wherein the logic determines that the parameters are invalid if the control register indicates that the type of picture is an I-picture and any of the one or more bits are in the particular state.

7. The circuit of claim 5, wherein the logic determines that the parameters are invalid if the control register indicates that the type of picture is a B-picture and less than two of the one or more bits are in the particular state.

8. A method for determining addresses for reference pixels, said method comprising:
receiving parameters, the parameters comprising a picture type indicator for indicating a type of a picture; and
determining the validity of the parameters; and
calculating one or more addresses after determining the validity of the parameters, if the parameters are valid.

9. The method of claim 8, further comprising:
fetching pixels from the one or more addresses after determining the validity of the parameters, if the parameters are valid.

10. The method of claim 8, wherein determining the validity of the parameters is based on the picture type indicator and the number of motion vectors received.

11. The method of claim 10, wherein determining the validity of the parameters further comprises determining that the parameters are invalid if the type of picture is an I-picture and any motion vectors are received.

12. The method of claim 10, wherein determining the validity of the parameters further comprises determining that the parameters are invalid if the control register indicates that the type of picture is a B-picture and less than two of the one or more bits are in the particular state.

13. A video decoder for decoding macroblocks, said video decoder comprising:
a processor for decoding a set of parameters, said set of parameters comprising:
a picture type parameter indicating a type of picture; and
motion vectors indicating reference pixels associated with the macroblock;
a motion vector address computer for determining the validity of the set of parameters, and calculating addresses associated with motion vectors if the set of parameters are valid; and
a video request manager for fetching reference pixels at the addresses calculated by the motion vector address computer, if the motion vector address computer determines that the set of parameters are valid.

14. The video decoder of claim 13, wherein the motion vector address computer further comprises:
an input for receiving parameters, the parameters comprising a picture type indicator for indicating a type of a picture; and
logic for determining whether the parameters received by the input are valid.

15. The video decoder of claim 14, wherein the motion vector address computer further comprises:
an arithmetic logic unit for calculating one or more addresses after the logic determines that the addresses are valid.

16. The video decoder of claim 14, wherein the logic determines whether the parameters received by the input are valid based on the picture type indicator and the number of motion vectors received by the input.

17. The video decoder of claim 16, wherein the motion vector address computer further comprises:
a control register for providing the type of pictures and indicating the number of motion vectors received to the logic.

18. The video decoder of claim 17, wherein the motion vector address computer further comprises:
one or more motion vector registers for storing motion vectors received by the input; and
wherein the control register comprises one or more bits, each of which are associated with a corresponding one or the one or more motion vector registers, wherein the one or more bits are in a particular state, based on whether the corresponding motion vector register stores a motion vector.

19. The video decoder of claim 18, wherein the logic determines that the parameters are invalid if the control register indicates that the type of picture is an I-picture and any of the one or more bits are in the particular state.

20. The video decoder of claim 18, wherein the logic determines that the parameters are invalid if the control register indicates that the type of picture is a B-picture and less than two of the one or more bits are in the particular state.
